(19) United States
(12) Patent Application Publication
(10) Pub. No.: US 2014/0324728 A1
(43) Pub. Date: Oct. 30, 2014

(54) SYSTEM AND METHOD FOR PROGRESSIVE FEEDBACK COLLECTION AND REVIEW

(71) Applicant: Lifeworx, Inc., Chappaqua, NY (US)

(72) Inventor: Bal Agrawal, Chappaqua, NY (US)

(73) Assignee: Lifeworx, Inc., Chappaqua, NY (US)

(21) Appl. No.: 13/869,590

(22) Filed: Apr. 24, 2013

(51) Int. Cl. G06Q 30/02

(52) U.S. Cl. CPC G06Q 30/0282
USPC 705/347

(57) ABSTRACT

Disclosed are systems and methods for the collection and display of linked feedback about a party to multiparty interactions involving a series of events. The disclosed system creates improved feedback by collecting feedback about a party from other participants to an interaction and collecting feedback from the party about the other participants. This feedback is then in a user interface displaying multiple instances of progressive multiparty feedback for an interaction.

### FIELD

The present application generally relates to feedback for quality and reputation assessments. More specifically, the present disclosure describes computerized systems, methods and apparatuses for improved collection, recordation and review of feedback for counterparties to a series of progressive transactions. Transaction in the context of the present disclosure refers to any interaction, exchange or other event involving multiple parties.

### BACKGROUND

Feedback is an important aspect of most businesses because it is through feedback that reputations are developed. Reputations, in turn, are a vital mechanism in both attracting new customers and maintaining existing customers. New customers are less likely to invest time and effort with a business or an individual that has a poor or unknown reputation; and existing customers are less likely to move their business to a competitor if they are currently working with a business with a high reputation.

The feedback that creates a business's reputation can come from many sources, such as word of mouth, formal certifications, market research surveys, awards, reviews from traditional media, reviews from on-line media or user generated crowd sourced reviews. Over the last few years user generated reviews, enabled by the Internet, have become an increasingly important component of a business's reputation because they provide access to a wealth of knowledge about a business. Indeed, the Internet makes it likely that even for businesses that interact with a relatively low number of customers (such as individual or small business service providers) feedback will be collected and recorded.

The publication of feedback based on small numbers of interactions, however, can create problems that are not present when a high volume of feedback exists such as for products and medium to large businesses. A low quantity of feedback overemphasizes the judgments of the few people that provided feedback and allow parties looking to game the system to create fake feedback that can dramatically and undeservedly impact a business's reputation. Having a small number of feedbacks also cause a problem when feedback is aggregated into higher-level ratings such as a scale of 1 to 10, stars or letter grades. While this aggregation of feedback into a bottom line evaluation has the advantage of being easy to review and grasp, there is the downside that aggregate ratings are of questionable value when they are based on a small number of reviews and the reviews are not defined.

### SUMMARY OF INVENTION

Innovative systems and methods for gathering, storing and reviewing reputational feedback are disclosed for addressing the above problems. The disclosed systems and methods are applicable to most situations where low volumes of feedback make it difficult to develop a sufficient number of feedback entries to allow reliance on the statistical validity of the aggregate feedback ratings, which is so common for restaurants, hotels and other mass market consumer products. The disclosed systems and methods are particularly useful in home service industries, such as, for example, personal care, housekeeping, childcare, eldercare, lawn and home maintenance or construction.

The disclosed systems and methods improve upon existing feedback systems by gathering and displaying feedback on a progressive series of events in an interaction. This, along with other aspects of the disclosed system, has the benefit of increasing the amount of information available about the businesses reviewed and increasing the reliability of that information. The system operates to track interactions between the parties to a transaction on an event-by-event basis. After events in an interaction the system queries the participants to the event for feedback and records that feedback. If a participant fails to respond to requests for feedback that fact is also recorded as a form of feedback, e.g., an entry indicating no feedback provided is recorded or the system indicates when providing output reporting on the interaction that no feedback was recorded.

The process is repeated for each event in the transaction. For example, if the transaction involves a homeowner seeking a housekeeper, the first event in the transaction might be the homeowner's review of the housekeeper's resume or profile. The second event might be a telephone interview and the third event might be an in-person interview or a first day on the job.

The disclosed system also collects feedback from multiple parties to the interaction, e.g., the job provider and the job seeker and the broker. By recording feedback from each event in a transaction and from each party a more complete view of the qualities of the business, or service provider, is developed. In particular, by soliciting counterparty feedback more context is provided, which improves the ability of readers of the review to evaluate the business. For example, it could give a sense of whether a feedback provider is being an unreasonably hard or an unreasonably easy judge.

The present system also provides an improved user interface for displaying the information collected. The feedback is preferably presented in a view showing two or more events in a particular transaction along with feedback from the participants for each event in the interaction. The user interface can provide this information in a participant view that further displays other transactions for a particular participant, including a series of two or more events for multiple participants to the interaction. In the case of multiple participants to a series of events, it is like a multi-dimensional lattice in storage space having two or three dimensional information is presented on the screen. The user interface further provides a mechanism to change to a participant view for other participants in the transaction, such that multiple interactions for that participant can be studied.

One embodiment of the disclosed system provides a computerized system or method of collecting and storing feedback that is accomplished by initiating feedback tracking for an interaction having at least two participants to the interaction by generating an interaction record in a feedback database and associating the participants with the interaction in the feedback database; receiving a first event notification associated with the specified interaction and generating a first event record associated with the interaction record in the feedback database; in response to receiving the first event notification initiating a request for feedback associated with the first event from the participants; receiving feedback from at least one responding participant of the at least two participants pertaining to another participant of the at least two participants and storing the feedback in the interaction database in a record associated with the responding participant, the other participant and the first event; receiving a second event notification associated with the specified interaction and generating a second event record associated with the interaction record in the feedback database; in response to receiving the second event notification initiating a request for feedback associated with the second event to the participants; and receiving feedback from a plurality of the at least two participants and storing the feedback in the interaction database in a record associated with the second event, wherein each feedback received is also associated with the participant providing the feedback and another participant to whom the feedback pertains. This method is preferably performed by creating computer code for carrying out the described steps, storing that code in non-volatile memory accessible by a computer system and then using the computer system to access and run that code as needed.

Another embodiment is provided by the further initiation of feedback tracking comprising receiving a request for feedback tracking that includes the identification of a specified interaction type and identifying information for the at least two participants. And in a further embodiment the initiation of feedback tracking comprises automatically initiating feedback tracking in response to a start of the interaction, and optionally, wherein the receipt of the first event notification comprises the start of the interaction.

In another advantageous embodiment the initiation of the first request for feedback comprises sending an electronic message to one or more of the participants and the electronic message can be an SMS message; an email message; a mobile application notification, or another suitable electronic communication means. In suitable situations the electronic message includes an interface for providing feedback. Alternately, the method the initiation of the first request for feedback comprises prompting a user to call the participants.

In order to try and encourage the providing of feedback, the system can further include a step of notifying one of the at least two participants who has not provided feedback that the responding participant has provided feedback pertaining to the participant that has not provided feedback. But when no feedback is provided it may be advantageous to store an entry indicating no feedback provided in an event record if one of the at least two participants has not provided feedback after a predetermined amount of time.

In a further embodiment a system and method for displaying the collected feedback is provided comprising receiving a request to display feedback pertaining to one of the at least two participants and in response to the request: accessing interaction records associated with the participant identified in the request; transmitting a structured page description data stream comprising data instructions describing the display of: the name of the identified participant, at least one interaction involving the identified participant, at least three events from the at least one interaction, and feedback by the identified person about first other participant and feedback about the identified participant by the first other participant for each of the three events, wherein the data instructions further include an interface element that allows selection of at least one of the other participants to initiate display of feedback for interactions involving the selected participant. Optionally, the structured page description data stream can further include data instructions describing the display of at least three interactions involving the identified participant, wherein each interaction shows feedback about at least two events, including feedback by the identified person about other participants of each event and feedback about the identified participant by the other participants for each of the two events.

While the disclosed systems and methods are mostly described in the context of commercial interactions, such as employment or service provider feedback, it will be readily apparent to a person of skill in the art that the disclosed systems and methods are equally applicable to non-commercial interactions, such as providing feedback about prospective dates in a matchmaking service.

### BRIEF DESCRIPTION OF THE DRAWINGS

FIG. 1 shows an exemplary overview of feedback system.

FIG. 2 shows an exemplary overview of process for feedback gathering.

FIG. 3 shows an exemplary interface for displaying feedback content.

FIG. 4 shows an exemplary systemization in accordance with the current disclosure.

### DETAILED DESCRIPTION

The present disclosure describes a number of methods and computerized systems for generating and displaying interaction feedback. An interaction in this context comprises a series of related events between multiple parties. One example of an interaction is the process of interviewing for a job and starting work. This interaction comprises a number of events for both the employer and a prospective employee. A first event might involve the employer reviewing resumes or profiles of various applicants and the prospective employee reviewing various job descriptions. A second event might involve an interview between the employer and the employee. A third event in the case of service provider such as a personal trainer, tutor, geriatric nurse, housekeeper or a cook might be an initial work assignment.

The particular events in an interaction can naturally vary according to the circumstances of the transaction. For example, in some interview environments there might be callback interviews, which would be an additional event. And when the feedback system is applied to interactions that do not involve work placement, the events would be different such as the initial showing of a house to potential buyer. The system can be adapted by an implementer to capture counterparty feedback from any of the constituent events that make up the interaction. For example, in the context of a dating service interaction the events could include, reviewing a profile, chatting on the phone, and having a first date.

After each tracked event, feedback is requested from each party to the event. Capturing counterparty feedback for each tracked event in an interaction has a number of advantages compared to feedback systems that only record a single feedback from one party to an interaction. Capturing feedback after each event in an interaction adds additional granularity. Not only does this result in more information about the parties to the transaction but it also provides context for the comments provided. By gathering information from both sides to the transaction later reviewers will be better able to judge if one party or the other was being unreasonable in its assessment. Another advantageous aspect of the process would be to request the event feedback shortly after the time of the event to record the information when it is fresh in the mind of the feedback provider. It can also be advantageous to notify the party to the transaction that its counterparty has provided feedback, as this would encourage them to provide feedback too. It may be disadvantageous to show the party the content of the counterparty's feedback. Preventing a party from seeing its counterparty's feedback may help avoid the situation where a party provides defensive or reactionary feedback in response to feedback directed at it.

While the system is described with respect to two counterparties to an interaction, the feedback from more parties to the interaction can be collected as the particular situation warrants. Gathering the additional interaction feedback could be particularly useful in situations where a neutral third party, such as a job placement agent or a real estate agent, is also involved in the interaction because it may provide objective insight regarding the participants and their interaction.

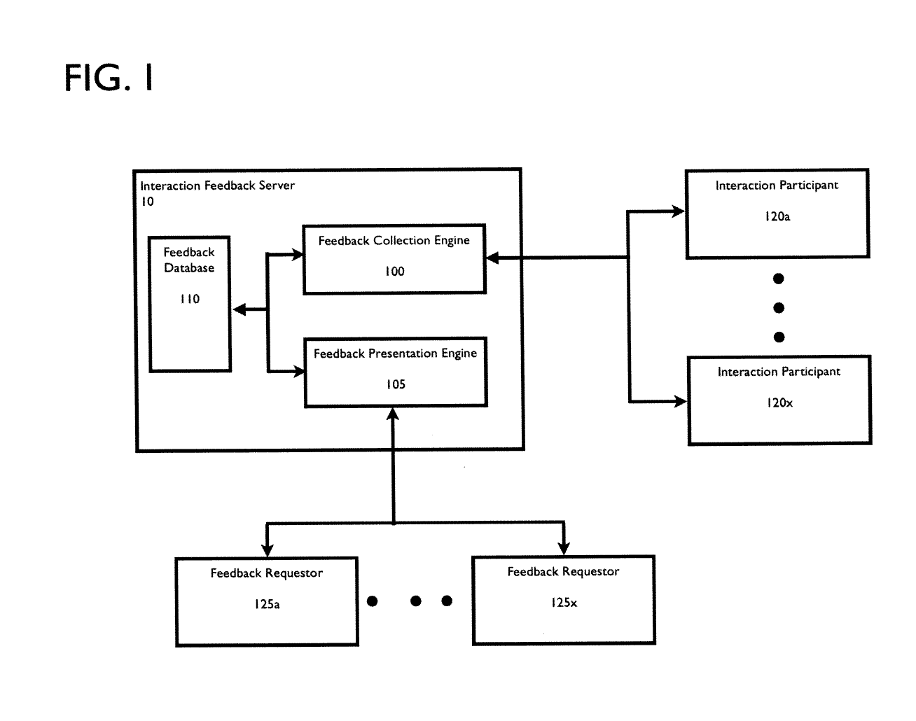

FIG. 1 shows an overview of a system to collect and display feedback in accordance with presently disclosed systems and methods. In the embodiment of FIG. 1, interaction feedback server 10 is a network-connected computer containing program logic to perform the disclosed methods. As one of skill in the art would recognize the various processes performed by the interaction feedback server 10 could be distributed over a number of different connected processors or computers without departing from the teachings of the disclosed system. The arrows connecting various elements of the interaction feedback server and the other entities shown disclose general information flow rather than specific hardware or network architectures, which could be chosen from architectures known in the art.

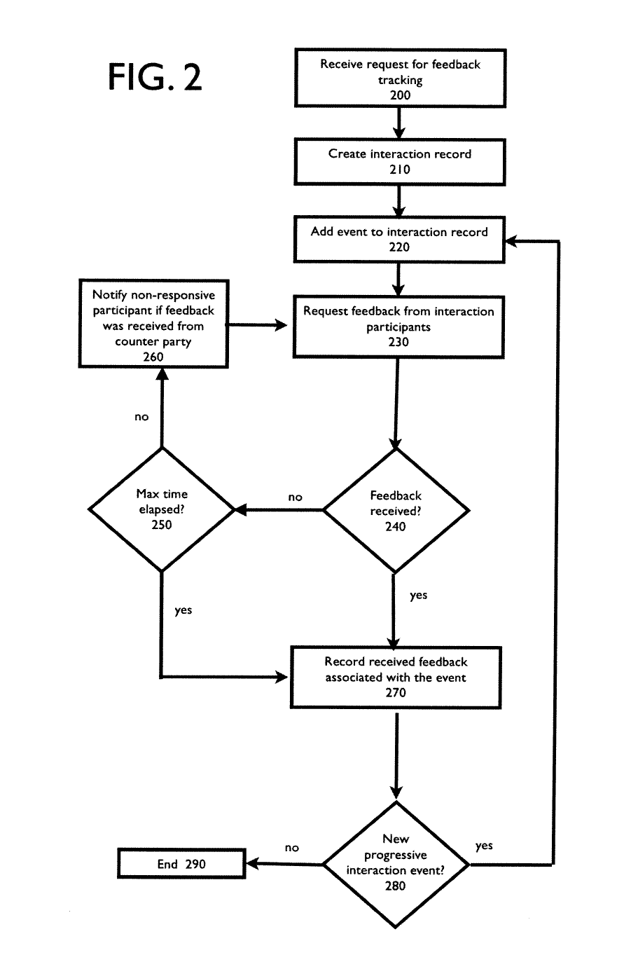

The interaction feedback server comprises a number of functional units, which are typically embodied by software routines. Feedback collection engine 100 communicates with interaction participants 120a-120x to solicit and receive feedback over a communications network. FIG. 2, discussed below, shows an exemplary method performed by feedback collection engine 100.

In a preferred embodiment the feedback collection engine provides a webserver interface that communicates with the interaction participants 120 over the Internet. The interaction participants can use computers or other suitable devices to communicate with the feedback collection engine. Alternately, this aspect of the communications interface could be performed by a network connected application or App (such as, mobile application for iOS, Android, Blackberry or Windows Phone). As a further alternative, the communications interface could be embodied by a private interface directly connected to the interaction feedback server. In this embodiment, an employee of the feedback service could input the feedback information directly into the system. Feedback can also be recorded in audio or video format to give more flexibility of retrieval as well as greater perspective on the feedback. Persons of skill in the art will readily recognize other possible input interfaces and apparatuses can be employed as necessary.

The information received by the feedback collection engine 100 is stored in the feedback database 110 of the interaction feedback server 10. The feedback database 110 is a structured set of data recording the relevant information about the interactions, events and participants. The data in the database is linked such that feedback information can be accessed on an interaction or on a participant basis. This can be accomplished with a variety of systems known in the art.

The interaction feedback server also comprises a feedback presentation engine 105. The feedback presentation engine 105 can access the feedback database 110 and issue reports regarding the collected feedback to feedback requestors 125. People seeking to review the recorded feedback use the feedback requestors to access the interaction feedback server. The feedback requestors could be embodied by network connected computers suitably configured to communicate with the interaction feedback server and the feedback presentation engine. In response to a feedback request the feedback presentation engine can poll the feedback database and transmit the data requested by the feedback requestor. This could be done by the transmission of code representing page description instructions, such as HTML. Alternatively, a client application could be provided to the requestor, where the client application specifies the user interface layout and the feedback presentation engine merely supplies the required data.

In a preferred embodiment the feedback presentation engine provides a webserver interface that communicates with the with the feedback requestors over the Internet. The feedback requestors can use computers or other suitable devices to communicate with the feedback presentation engine. Alternately, this aspect of the communications interface could be performed by a network connected application or App (such as, mobile application for iOS, Android, or Windows Phone). As a further alternative, the communications interface could be embodied by a private interface directly connected to the interaction feedback server. In this embodiment, a user local to the interaction feedback server could directly access the feedback information through a locally connected computer. Persons of skill in the art will readily recognize other possible input interfaces and apparatuses can be employed as necessary.

FIG. 2 shows an exemplary process suitable for embodying the feedback collection engine. The process begins with the receipt of a request for feedback tracking 200. The request would typically include an identification of the interaction for which feedback is requested and the participants in the interaction. The request could also include additional useful information. For example, the type of interaction being tracked could be provided, which could in turn be used by the system to tailor the feedback requests and other operation of the feedback collection engine. In some situations the time period or the feedback media could be chosen.

The feedback collection engine next uses the received information to create an interaction record 210. The interaction record is generated in the feedback database 110. This may require creating new records for the interaction participants if they do not already exist in the database, or linking the new interaction record with the participants if they already have records in the database.

Next, the feedback collection adds an event to the interaction record 220. In the first loop through the process the event would be the first event in the interaction. The events in the interaction could be identified in a number of convenient ways, such as numerical order or by date. The event record might also include a description of the event. For example, if the interaction is a job interview process the first event might be described as initial review. For the potential employer this might be the review of a profile or resume. For the applicant this might be the review of the job description. Any of these data items could optionally be captured in the event record. Alternatively, the feedback collection engine could automatically populate these additional descriptions or a description of the event could be requested from the interaction participant as part of the feedback request. In the embodiment of creating or adding the initial event, the initial event record is created by the system with the information available in the system. Such an approach limits the possibility of human error and automates the process for higher accuracy.

The feedback collection engine then requests feedback from the interaction participants 230. The requests to the interaction participants can be communicated in a wide variety of ways such as: email, telephone, mobile application notification, SMS or any other messaging architecture. In a preferred embodiment, the request is communicated shortly after the event occurs in order to try and obtain feedback when the experience is fresh in the participants' minds. The timing of the request could be triggered by at a pre-programmed time based on an event schedule. Or a process could notify the feedback collection engine that the event is complete in order to trigger the request. While the request is preferably sent shortly after the completion of the event, the process is asynchronous and could optionally be performed on different time schedules. Other timings issues can be dealt with as needed. For example, where resume or job review is a relevant event, it might be advantageous to hold off on sending a request for feedback until the participant has decided to move forward with a particular job. Otherwise, it might be annoying to the users of the system to be asked for feedback too frequently. As an alternate initiation process, the system creates the record of the event and records no data and prompts an agent to seek input personally. The agent could then input the feedback into the record.

After the requests are transmitted, the feedback collection engine awaits responses from the interaction participants, branch 240. If feedback is received from an interaction participant the process for that participant proceeds down the “yes” branch 240 to step 270 where the feedback for the event is recorded in the feedback database such that it is associated with the interaction, event, the feedback providing participant and the participant about whom the feedback pertains.

If no feedback is received after some time the process of the “no” branch 240 is performed. The “no” branch of step 240 embodies a loop that periodically sends reminder requests for feedback to the participant. In the first step after the “no” branch a check 250 is made to determine whether a maximum time to respond to the request has been reached. This time can be set to match the needs of the particular implementation and it operates to recognize that after a certain amount of time it is unlikely that an interaction participant will respond. Rather than a specific amount of time, the check 250 could be operated based on whether a certain number of reminders had previously been set. As a further alternative, the check 250 can be made based on whether or not the next event in the interaction has occurred, in which case feedback for the prior event might be closed. In either event, once check 250 determines that feedback is unlikely to be received from the interaction participant, the “yes” branch is followed and a record is made in the feedback database that no feedback was provided. While it is not imperative that a no response entry is made into the database, it is believed that for the currently preferred embodiment of the disclosed system indicating that no feedback was provided is a form of feedback in its own right.

While the yes branch of step 250 assumes that no feedback will be provided, it is possible that an interaction participant may attempt to provide feedback after the system has determined that no feedback will be provided. In this event, the system could enter the late received feedback or discard the late feedback. The implementer of the system can choose whether to tune the system for more feedback and accept the late feedback. Or, the implementer can decide that late feedback is less trustworthy and exclude the feedback. Or, a mix of the two approaches could be employed such that feedback is recorded but the lateness is identified.

Returning to step 250, if the max time has not elapsed, the interaction participant is reminded to submit feedback 230. These additional reminders could optionally include alternative or escalated modes of communication, for example a phone call from a live representative rather than an electronic message. Furthermore, as shown in step 260, the non-responsive interaction participant can be notified if the other counterparties to the interaction have provided feedback. This might have the benefit of spurring the non-responsive participant to provide feedback. The implementer of the system can choose whether or not to show the interaction participants the feedback about them provided by others before they have submitted feedback of their own. On the one hand, seeing the feedback provided by others could be a powerful motivator to encourage feedback. On the other hand, it might cause the second responding requestor to change their response in reaction to the feedback provided.

While the notification of feedback 260 and the subsequent request for feedback 230 are shown as two separate steps in FIG. 2. They can preferably be combined into one communication to the interaction participant.

After the loops comprising steps 230-270 are completed the process moves to step 280 to wait for the next progressive event. When the next progressive event in the interaction occurs, the process loops back up to step 220 and adds a new event record to interaction record in the feedback database. From there the process flow operates as described above. However, particular options for the operation of the feedback request process could be tailored on an event-by-event basis such that the request procedures for two different events in one interaction operate differently.

If no further progressive events occur, the procedure ends at step 290. This ending procedure can be explicit or implicit. In an explicit ending embodiment the system could operate such that a certain event (such as the start of a job), number of events (for example 3), or time period trigger the end of the feedback request process. When an explicit ending operation is implemented there may be certain triggers or other operations that are conducted with the ending procedure, for example the records generated during the interaction could be forwarded to personnel for review and/or recording a data item in the feedback database stating the interaction is complete. Alternately, the system could operate with an implicit ending such that a further event could be accepted at times into the future and the ending occurs without the system taking any explicit action.

The feedback presentation engine 105 uses the information collected in the feedback database to report the feedback received by various interaction participants to feedback requestors 125. The feedback presentation engine provides a user interface, preferably via a web page or App, that enables the feedback requestors to view interaction participant feedback. The feedback can be presented, for example, during the process of browsing interaction participants as part of a service relevant to the underlying interactions. For example, if the system is being used in a household employment service context, the feedback information could be shown automatically as a user browses a particular service provider or employer. Or, a user browsing the service could access the information by clicking a link to show the feedback content. Of course, other interface paradigms for accessing the data could be employed such as mobile apps, telephone or speech interfaces.

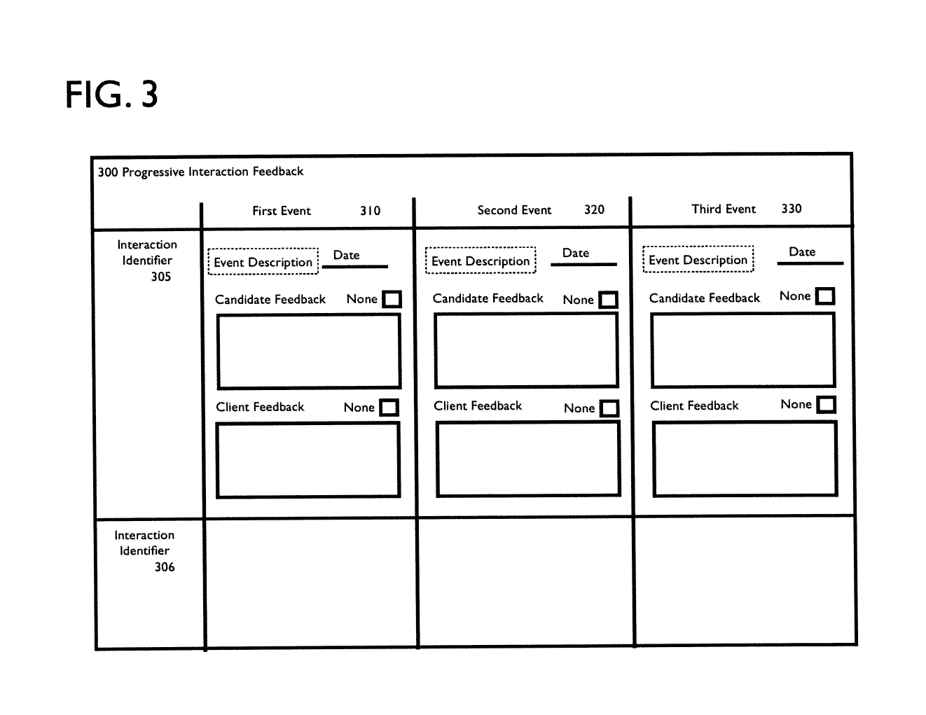

In a particularly advantageous embodiment the feedback is provided by the feedback presentation engine in a format such as is shown in progressive interaction feedback interface 300 of FIG. 3. The progressive interaction feedback interface is designed to show multiple events between two participants and multiple series of interactions for the chosen participant, when available. It has been found to be particularly advantageous to show at least three events in an interaction to provide sufficient context to the feedback for the interaction participants. In the embodiment of FIG. 3 the events 310, 320 and 330 are arranged by interaction horizontally, while further interactions are displayed vertically, e.g., 305 and 306. While this is the currently preferred organization, other organizational formats would be suitable such as arranging the series of events vertically and listing the interactions horizontally.

The information in the feedback interface includes an identifier 305. The identifier can provide basic information about the interaction, such as the interaction type and participants. In the FIG. 3 embodiment, it is assumed that the over all display is for a particular interaction participant. Thus, the identifier need not mention the primary participant in that case.

User interface elements, such as links, can be provided for the other participants in the interaction such that they can be shifted to a primary view. For example, in the context of a dating site a particular person might be the primary view and feed back would be displayed for multiple interactions of the person shown in the primary view. If a user wants more context regarding the feedback provided by one of the primary person's counterparties, the user can click a link associated with that counterparty's name to see other interactions involving the counterparty. This two or more party view provides an invaluable insight into the way each party gives feedback, has expectations and makes judgments. In a multi-party situation, such buyers and sellers dealing with a real estate agent, by clicking on the link, the parties can provide their assessment of the agent.

Each progressive event in the interaction is listed in a column 310, 320 and 330. An event description and date is provided to specify the type of event and when it occurred. The event records include the feedback of each interaction participant. In the FIG. 3 example, a bi-lateral interaction is shown so the feedback for only two interaction participants is provided. In this case, the interaction is a job search so the interaction participants are a candidate and a client. However, in interactions involving more participants additional feedback can be accommodated. An interface element is also provided to show that no feedback was provided. Other data can be included as pertinent for the particular implementation.

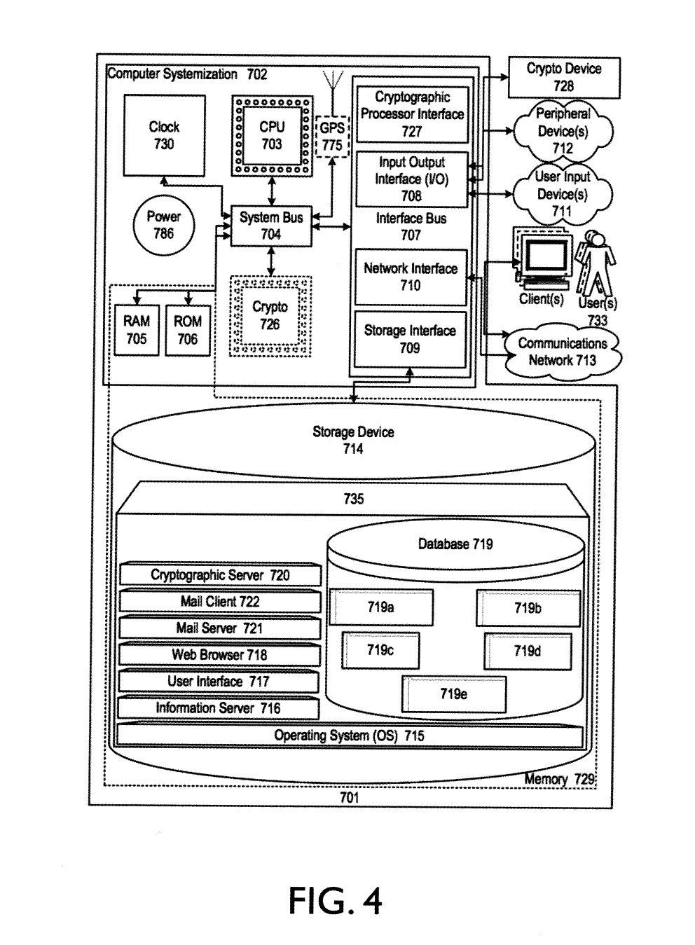

A particularly advantageous embodiment of the present invention is obtained by using a feedback service controller to embody the various features described above. FIG. 4 illustrates inventive aspects of a feedback service controller 701 in a block diagram. In this embodiment, the feedback service controller 701 may serve to accept, retrieve, store, search, serve, submit, identify, transmit, instruct, generate, match, and/or update databases containing relevant information and/or service provider information and/or related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the feedback service controller 701 may be connected to and/or communicate with entities such as, but not limited to: one or more users from user input devices 711; peripheral devices 712; and/or a communications network 713.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The feedback service controller 701 may be based on common computer systems that may comprise, but are not limited to, components such as: a computer systemization 702 connected to memory 729.

Computer Systemization

A computer systemization 702 may comprise a clock 730, central processing unit (CPU) 703, a read only memory (ROM) 706, a random access memory (RAM) 705, and/or an interface bus 707, and most frequently, although not necessarily, are all interconnected and/or communicating through a system bus 704. Optionally, the computer systemization may be connected to an internal power source 786. Optionally, a cryptographic processor 726 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron, Phenom, Sempron, FX and/or Opteron; ARM based processor; IBM and/or Motorola's PowerPC; Intel's Celeron, Itanium, Pentium, Xeon, Core, Atom and/or XScale; and/or the like processor(s). The CPU interacts with memory through signal passing through conductive conduits to execute stored program code according to conventional data processing techniques. Such signal passing facilitates communication within the feedback service controller and beyond through various interfaces. Should processing requirements dictate a greater amount speed, parallel, mainframe and/or super-computer architectures may similarly be employed. Alternatively, should deployment requirements dictate greater portability, tablets, smart phones or Personal Digital Assistants (PDAs) may be employed.

Power Source

The power source 786 may be of any standard form for powering small electronic circuit board devices such as the following power cells: alkaline, lithium hydride, lithium ion, nickel cadmium, solar cells, and/or the like. Other types of AC or DC power sources may be used as well. The power cell 786 is connected to at least one of the interconnected subsequent components of the feedback service controller thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (WEE) 1394, fiber channel, Small Computer Systems Interface (SCSI), Universal Serial Bus (USB), and/or the like.

Network interfaces 710 may accept, communicate, and/or connect to a communications network 713. Through a communications network 713, the feedback service controller is accessible through remote clients 733b (e.g., computers with web browsers) by users 733a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to user input devices 711, peripheral devices 712, cryptographic processor devices 728, and/or the like. I/O may employ connection protocols such as, but not limited to: light peak, thunderbolt, lightning; audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), HDMI, RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites info′ nation generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 711 may be card readers, dongles, finger print readers, gloves, graphics tablets, joysticks, keyboards, mouse (mice), remote controls, retina readers, trackballs, touch screens, trackpads, and/or the like.

Peripheral devices 712 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the feedback service controller may be embodied as an embedded, dedicated, and/or monitor-less (i.e., headless) device, wherein access would be provided over a network interface connection.

Memory

Generally, any mechanization and/or embodiment allowing a processor to affect the storage and/or retrieval of information is regarded as memory 729. However, memory is a fungible technology and resource, thus, any number of memory embodiments may be employed in lieu of or in concert with one another. It is to be understood that the feedback service controller and/or a computer systemization may employ various forms of memory 729. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 729 will include ROM 706, RAM 705, and a storage device 714. A storage device 714 may be any conventional computer system storage. Storage devices may include a drum; a (fixed and/or removable) magnetic disk drive; SSD; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 729 may contain a collection of program and/or database modules and/or data such as, but not limited to: operating system module(s) 715 (operating system); information server module(s) 716 (information server); user interface module(s) 717 (user interface); Web browser module(s) 718 (Web browser); database(s) 719; cryptographic server module(s) 720 (cryptographic server); the feedback service module(s) 735; and/or the like (i.e., collectively a module collection). These modules may be stored and accessed from the storage devices and/or from storage devices accessible through an interface bus. Although non-conventional software modules such as those in the module collection, typically, are stored in a local storage device 714, they may also be loaded and/or stored in memory such as: peripheral devices, RAM, remote storage facilities through a communications network, ROM, various forms of memory, and/or the like.

Operating System

The operating system module 715 is executable program code facilitating the operation of the feedback service controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, iOS, Android, Microsoft DOS, Palm OS, Windows 8, Windows 7, Windows RT, Windows 2000/2003/3.1/95/98/CE/Millenium/NT/XP/Vista (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the feedback service controller to communicate with other entities through a communications network 713. Various communication protocols may be used by the feedback service controller as a subcarrier transport mechanism for interaction, such as, but not limited to: multicast, TCP/IP, UDP, unicast, and/or the like.

Information Server

An information server module 716 is stored program code that is executed by the CPU. The information server may be a conventional Internet information server such as, but not limited to Apache Software Foundation's Apache, Microsoft's Internet Information Server, and/or the information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the feedback service controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the feedback service controller, operating systems, other program modules, user interfaces, Web browsers, and/or the like.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, iOS, Microsoft's Windows 8, or Unix's X-Windows provide a baseline and means of accessing and displaying information graphically to users.

A user interface module 717 is stored program code that is executed by the CPU. The user interface may be a conventional graphic user interface as provided by, with, and/or atop operating systems and/or operating environments such as Apple Macintosh OS, e.g., Aqua, Microsoft Windows 8, Windows Vista, Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 718 is stored program code that is executed by the CPU. The Web browser may be a conventional hypertext viewing application such as Firefox, Chrome, Safari, Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into smart phones, tablets, PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the feedback service enabled nodes. The combined application may be nugatory on systems employing standard Web browsers.

Feedback Service Controller Module

The feedback service controller module 735 is stored program code that is executed by the CPU. The feedback service controller module affects accessing, obtaining and the provision of feedback service, and/or the like across various communications networks.

The feedback service controller module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. The feedback service controller module may communicate to and/or with other modules in a module collection, including itself, and/or facilities of the like. Most frequently, the feedback service controller module communicates with the feedback service database containing the data required to be stored by the system, operating systems, other program modules, and/or the like. The feedback service controller module may contain, communicate, generate, obtain, and/or provide program module, system, user, and/or data communications, requests, and/or responses.

Distributed Feedback Service Controller Module

The structure and/or operation of any of the feedback service controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the feedback service controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A computerized method of collecting and storing feedback comprising:
initiating feedback tracking for an interaction having at least two participants to the interaction by generating an interaction record in a feedback database and associating the participants with the interaction in the feedback database;
receiving a first event notification associated with the specified interaction and generating a first event record associated with the interaction record in the feedback database;
in response to receiving the first event notification initiating a request for feedback associated with the first event from the participants;
receiving feedback from at least one responding participant of the at least two participants pertaining to another participant of the at least two participants and storing the feedback in the feedback database in a record associated with the responding participant, the other participant and the first event;
receiving a second event notification associated with the specified interaction and generating a second event record associated with the interaction record in the feedback database;
in response to receiving the second event notification initiating a request for feedback associated with the second event to the participants; and
receiving feedback from a plurality of the at least two participants and storing the feedback in the feedback database in a record associated with the second event, wherein each feedback received is also associated with the participant providing the feedback and another participant to whom the feedback pertains.

2. The method of claim 1 wherein the initiation of feedback tracking comprises receiving a request for feedback tracking that includes the identification of a specified interaction type and identifying information for the at least two participants.

3. The method of claim 1 wherein the initiation of feedback tracking comprises automatically initiating feedback tracking in response to a start of the interaction.

4. The method of claim 3 wherein the receipt of the first event notification comprises the start of the interaction.

5. The method of claim 1 wherein initiating the first request for feedback comprises sending an electronic message to one or more of the participants.

6. The method of claim 5 wherein the electronic message is one of the following: an SMS message; an email message; or a mobile application notification.

7. The method of claim 5 wherein the electronic message includes an interface for providing feedback.

8. The method of claim 1 wherein initiating the first request for feedback comprises prompting a user to call the participants.

9. The method of claim 1 further comprising notifying one of the at least two participants who has not provided feedback that the responding participant has provided feedback pertaining the participant that has not provided feedback.

10. The method of claim 1 further comprising storing an entry indicating no feedback provided in an event record if one of the at least two participants has not provided feedback after a predetermined amount of time.

11. The method of claim 1 further comprising:
receiving a request to display feedback pertaining to one of the at least two participants and in response to the request:
accessing interaction records associated with the participant identified in the request; transmitting a structured page description data stream comprising data instructions describing the display of: the name of the identified participant, at least one interaction involving the identified participant, at least three events from the at least one interaction, and feedback by the identified person about first other participant and feedback about the identified participant by the first other participant for each of the three events, wherein the data instructions further include an interface element that allows selection of at least one of the other participants to initiate display of feedback for interactions involving the selected participant.

12. The method of claim 11 wherein the structured page description data stream further comprises data instructions describing the display of at least three interactions involving the identified participant, wherein each interaction shows feedback about at least two events, including feedback by the identified person about other participants of each event and feedback about the identified participant by the other participants for each of the two events.

13. A computer system for collecting and storing feedback comprising:
a processor;
a memory connected to and in communication with the processor and containing processor executable instructions;
a network interface connected to the processor to provide network access to the processor;
a database for storing information;
wherein the processor is capable of executing instructions contained in the memory and the instructions are structured to cause the computer system to:
initiate feedback tracking for an interaction having at least two participants to the interaction by generating an interaction record in a the database and associating the participants with the interaction in the database;
receive a first event notification associated with the specified interaction and generate a first event record associated with the interaction record in the database and in response to receiving the first event notification initiate a request for feedback associated with the first event from the participants;
receive feedback from at least one responding participant of the at least two participants pertaining to another participant of the at least two participants and storing the feedback in the database in a record associated with the responding participant, the other participant and the first event;
receive a second event notification associated with the specified interaction and generating a second event record associated with the interaction record in the database and in response to receiving the second event notification initiate a request for feedback associated with the second event to the participants; and
receive feedback from a plurality of the at least two participants and store the feedback in the database in a record associated with the second event, wherein each feedback received is also associated with the participant providing the feedback and another participant to whom the feedback pertains.

14. The system of claim 13 wherein the initiation of feedback tracking comprises receipt of a request for feedback tracking that includes the identification of a specified interaction type and identifying information for the at least two participants.

15. The system of claim 13 wherein the initiation of feedback tracking comprises automatically initiating feedback tracking in response to a start of the interaction.

16. The system of claim 15 wherein the receipt of the first event notification comprises the start of the interaction.

17. The system of claim 15 wherein initiation of the first request for feedback comprises sending an electronic message to one or more of the participants.

18. The system of claim 17 wherein the electronic message is one of the following: an SMS message; an email message; or a mobile application notification.

19. The system of claim 17 wherein the electronic message includes an interface for providing feedback.

20. The system of claim 13 wherein initiation of the first request for feedback comprises prompting a user to call the participants.

21. The system of claim 13 the instructions further comprising code to notify one of the at least two participants who has not provided feedback that the responding participant has provided feedback pertaining the participant that has not provided feedback.

22. The system of claim 13 the instructions further comprising the to store an entry indicating no feedback provided in an event record if one of the at least two participants has not provided feedback after a predetermined amount of time.

23. The method of claim 13 further comprising instructions to:
receive a request to display feedback pertaining to one of the at least two participants and in response to the request:
access interaction records associated with the participant identified in the request; transmit a structured page description data stream comprising data instructions describing the display of: the name of the identified participant, at least one interaction involving the identified participant, at least three events from the at least one interaction, and feedback by the identified person about first other participant and feedback about the identified participant by the first other participant for each of the three events, wherein the data instructions further include an interface element that allows selection of at least one of the other participants to initiate display of feedback for interactions involving the selected participant.

24. The method of claim 23 wherein the structured page description data stream further comprises data instructions describing the display of at least three interactions involving the identified participant, wherein each interaction shows feedback about at least two events, including feedback by the identified person about other participants of each event and feedback about the identified participant by the other participants for each of the two events.
